(19) United States
(12) Patent Application Publication
(10) Pub. No.: US 2018/0079395 A1
(43) Pub. Date: Mar. 22, 2018

(54) TRAILER BRAKE CONTROL UNIT CONTROLS AND COMMUNICATIONS

(71) Applicant: HORIZON GLOBAL AMERICAS INC., Plymouth, MI (US)

(72) Inventors: Nicholas Albert Cekola, Plymouth, MI (US); Dennis Michael Morse, Plymouth, MI (US); Srikanth Kadudula, Plymouth, MI (US)

(21) Appl. No.: 15/707,408

(22) Filed: Sep. 18, 2017

Related U.S. Application Data
(60) Provisional application No. 62/395,543, filed on Sep. 16, 2016.
(60) Provisional application No. 62/395,533, filed on Sep. 16, 2016.

(51) Int. Cl. B60T 7/20; B60T 7/10; H04H 60/13; B60T 8/17

(52) U.S. Cl. CPC B60T 7/20; B60T 8/1708; H04H 60/13; B60T 7/107

(57) ABSTRACT

A brake control unit generates an output signal to the brakes of a towed vehicle directly related to a variety of input signals sent from the towing vehicle, the towed vehicle, the operator, or a combination of any of the three. The brake control unit communicates input signals between a first module and a second module. The first module may include at least one manual input device. The second module may include power circuitry and a processor. The first module may communicate with the second module with LIN communication bus. The brake control unit may include a trailer brake gain switch attached with a steering wheel of a towing vehicle, a trailer brake manual override control attached with the steering wheel, and a brake control unit driver operatively coupled with the trailer brake gain switch and trailer brake manual override.

### CROSS-REFERENCE TO RELATED APPLICATION

This application claims the benefit of U.S. Provisional Patent Application Ser. No. 62/395,543, filed on Sep. 16, 2016 and entitled “TRAILER BRAKE CONTROLLER CONTROLS ON STEERING WHEEL,” and U.S. Provisional Patent Application Ser. No. 62/395,533, filed on Sep. 16, 2016 and entitled “LIN COMMUNICATION FOR A TRAILER BRAKE CONTROLLER,” the entireties of which are incorporated herein by reference.

### FIELD OF THE INVENTION

The present invention relates generally to brake control units, and more specifically, to communication with controls for a brake control unit integrated into a towing vehicle.

### BACKGROUND OF THE INVENTION

Modern automotive networks have used local interconnect network (LIN) communications as an embedded networking standard for connecting intelligent devices within a vehicle. LIN bus has been used with low-cost applications primarily in body electronics and may be coupled with other communication protocols such as the controller area network (CAN) which has been used with mainstream powertrain and body communications. Various other communication protocols are used in advanced automotive systems such as with active suspension systems.

The LIN bus was developed to create a standard for low-cost, low-end multiplexed communication in automotive networks. The CAN bus has been used for high-bandwidth, advanced error-handling networks, however, the hardware and software costs of CAN implementation may be cost prohibitive for lower performance devices such as power window and seat controllers.

The LIN bus is an inexpensive serial communications protocol, which effectively supports remote application within a network. It is particularly intended for mechatronic nodes in distributed automotive applications, but is equally suited to industrial applications. It is intended to complement the existing CAN network leading to hierarchical networks within cars.

A variety of prior art brake control systems are known to electrically communicate between the brakes of a towed vehicle, the towing vehicle, and the brake control units. One example of such a brake control unit is provided by U.S. Pat. No. 8,746,812, which is incorporated by reference in its entirety. Generally, most current brake control units are not integral with the towing vehicle's instrument panel. They may be aftermarket units which may not be able to communicate with and communicate over existing systems within the towing vehicle. Additionally, brake control unit systems generally include electrical hookups with a wiring harness having a high number of conductors to communicate between the towed and towing vehicles, brake control unit, and the brakes.

A variety of prior art brake control units that provide a brake output signal to the brakes of a towed vehicle have been proposed and/or manufactured. One example of such a brake control unit is provided by U.S. Pat. No. 8,746,812, which is incorporated by reference in its entirety.

Most current brake control units are not integral with the towing vehicle. They are aftermarket units that are positioned in the towing vehicle in any available space. The brake control units may be difficult to access while a driver is positioned in the driver's seat, i.e., when in a driving position. This may require a driver to stretch over a center console, reach under the dashboard, reach under the steering wheel or otherwise have to extend to operate the trailer brake control unit. This can be inconvenient for the driver.

Therefore, there is a need a trailer brake control unit that is easy to access and operate. There is a need for a trailer brake control unit that is more integrated into and with a towing vehicle. Further, it may be desirable to provide a brake control system and method for improving the communications capability of the brake control system with the brake control unit, towing vehicle, and towed vehicle. It also may be desirable to reduce the total amount of conductors and size of the wire harness between the towed vehicle and the towing vehicle.

### SUMMARY OF THE INVENTION

Disclosed is a communication system and method for a brake control system. The brake control system may include a brake control unit that generates an output signal to the brakes of a towed vehicle directly related to a variety of input signals sent from the towing vehicle, the towed vehicle, the operator, or a combination of any of the three. An embodiment of the present disclosure is directed to a method for communicating input signals between a first module and a second module. The first module may include at least one manual input device. The second module may include power circuitry and a processor. The first module may communicate with the second module with LIN communication bus.

According to yet another embodiment of the present disclosure, a brake control unit comprises a processor, a first module, and a second module. The first module includes at least one manual input device and the second module includes at least one of power circuitry and a processor. The first module is in electrical communication with the second module with a LIN communication protocol. The first module may be installed within the towing vehicle at a position accessible to an operator of the towing vehicle. The second module may be installed within the towing vehicle or towed vehicle remote from the first module.

Disclosed is a brake control unit including a trailer brake gain switch attached with a steering wheel of a towing vehicle, a trailer brake manual override control attached with the steering wheel, and a brake control unit driver operatively coupled with the trailer brake gain switch and trailer brake manual override. The brake control unit may also have the trailer brake gain switch and trailer brake manual override controls that are integrated into the steering wheel.

Disclosed is a towing vehicle having a steering wheel, the vehicle including a trailer brake gain switch attached with the steering wheel, a trailer brake manual override control attached with the steering wheel, and a brake control unit driver operatively coupled with the trailer brake gain switch and trailer brake manual override.

The brake control unit may also have the trailer brake gain switch and trailer brake manual override control are integrated into the steering wheel.

These and other features, advantages and objects of the present invention will be further understood and appreciated by those skilled in the art by reference to the following specification, claims, and appended drawings.

### DESCRIPTION OF THE DRAWINGS

Objects and advantages together with the operation of the present teachings may be better understood by reference to the following detailed description taken in connection with the following illustrations, wherein:

FIG. 1 is a schematic diagram of a brake control system in accordance with the present disclosure;

FIG. 2 is an electrical block diagram of the brake control system according to an embodiment of the present disclosure;

FIG. 3 is a schematic diagram of LIN communication of the brake control system of the present embodiment; and

FIG. 4 is a schematic diagram representative of the brake control system of the present embodiment.

FIG. 5 is a front view of a steering wheel with components of a brake control unit included thereon.

FIG. 6 is a front view of a dashboard of a towing vehicle with a brake control unit incorporated therein.

FIG. 7 is a plan view of a towing and towed vehicles operatively connected with a trailer brake control unit and trailer brakes.

FIG. 8 is a schematic view of a portion of a trailer brake control unit.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Disclosed is a brake control system for a towed vehicle, e.g., a trailer, the brake control system may include a brake control unit that generates an output signal to the brakes of the towed vehicle to apply a certain brake load thereto. The output signal may be related to a variety of input signals received by the brake control unit from the towing vehicle, the towed vehicle, the operator, or any combination of the three.

A brake control unit may comprise a trailer brake control circuit comprising a processor that operatively generates an output signal to control brakes of a towed vehicle and an electrical connection coupled to the processor. The brake control unit may comprise a user interface operatively generating an input signal to be sent to the trailer brake control circuit in response to actuation of the user interface, wherein the user interface is coupled to the electrical connection via a local interconnect network bus. In another aspect, the user interface comprises a manual brake control mounted in a steering wheel. The manual brake control comprises a slide control. In an embodiment, the user interface comprises a gain control in a steering wheel. The gain control comprises a first control for increasing a gain setting and a second control for decreasing a gain setting.

According to at least one embodiment a brake control unit comprises a first module that comprises a controller coupled to at least one manual input device and a network transceiver coupled to the controller. The brake control unit may comprise a second module comprising a brake control circuit that generates an output signal to control brakes of a towed vehicle, wherein the network transceiver operatively converts a signal between the first module and the second module. The network transceiver may comprise a local interconnect network transceiver. It is noted that the first module may be physically separate from the second module. The first module further comprises a manual input device coupled to the controller. The brake controller may include a local interconnect network bus coupling the network transceiver to the second module.

Further disclosed is a brake control unit comprising a trailer brake control circuit that operatively generates an output signal to control brakes of a towed vehicle and a user interface coupled to the trailer brake control circuit and integrated with a steering wheel of a vehicle. The user interface includes at least one of a gain control, a light, or a manual brake control. The brake control unit may include a display coupled to the trailer brake control circuit and mounted in a different location than the user interface. It is noted that the brake control unit may be disposed within or comprise a housing. The housing may be removably disposed in a towing vehicle.

Additionally or alternatively, the brake control unit may have the capability of being mounted to a variety of locations on the towing or towed vehicle. Additionally, the brake control system may have the capability of allowing a human interface or display device to be mounted separate from a control circuit of the trailer brake control unit. This arrangement may rely on LIN communication bus for electrical contact between the human interface and the control circuit and may assist in allowing the brake control unit to be slender allowing it to be installed in various locations within the system while maintaining accurate communication.

A wide range of communication technologies are used for different applications, ranging from home automation to internet access. LIN is a broadcast serial network comprising a plurality of nodes usually with a single master and the remaining nodes being slaves. The master and slaves may be typically microcontrollers, but may be implemented in specialized hardware or ASICs in order to save cost, space, or power. LIN communication systems may be combined with simple devices to create small networks which may be connected by a back-bone-network (e.g., CAN, HSCAN, etc.).

The present brake control unit may be an original equipment manufactured (OEM) unit that is installed in the towing vehicle at the factory. Alternatively, the trailer brake control unit may be incorporated into the towing vehicle as an after-market component. The brake control unit of the present disclosure or a portion thereof can be installed on the towing vehicle steering wheel.

In another aspect, disclosed brake control units or a portion thereof can be installed in the dashboard of the towing vehicle, much like a car radio is. In either embodiment, the trailer brake control unit may be integrated with the towing vehicle as an electronic control device that provides variable braking power to brakes on a vehicle towed by the towing vehicle.

More specifically, the brake control unit generates and applies a particular voltage to the brakes of the towed vehicle so as to apply a brake load to slow-down or stop the towed vehicle. The voltage applied is related to the input signals available on and/or from the towing vehicle, among other available inputs. These additional input signals may come directly from the operator of the towing vehicle, from the towed vehicle, or a combination of any of the three.

The brake control unit may use a variety of preselected or continuously modified operator inputs to generate the appropriate output to the towed vehicle brakes based on the received inputs. A processor on the towing vehicle (although it may be located on the towed vehicle or brake control unit) receives the input signals from the source (such as the ABS system, a speed meter, the ignition, the brake pedal, other processors on the towing vehicle, etc.) and generates the appropriate output signal. The algorithms stored within the processor may be updated by having new algorithms entered therein or having the existing algorithms modified automatically or manually. It should be noted that the brake control unit may be capable of being reprogrammed meaning that the algorithms stored therein can be modified by a technician or a completely new set of algorithms may be entered therein by a technician. This allows the brake control unit to be updated with new information regarding the towing vehicle, the towed vehicle, or the brake control unit itself. The algorithms stored in the brake control unit may correspond to each unique combination of inputs. The selection of the appropriate algorithm or algorithms is done by the processor once it receives the appropriate input information. Further, depending upon changes in the input(s), the processor may select a different algorithm or algorithms to generate the appropriate brake output signal. The processor may receive the input signals and generate an appropriate brake output signal.

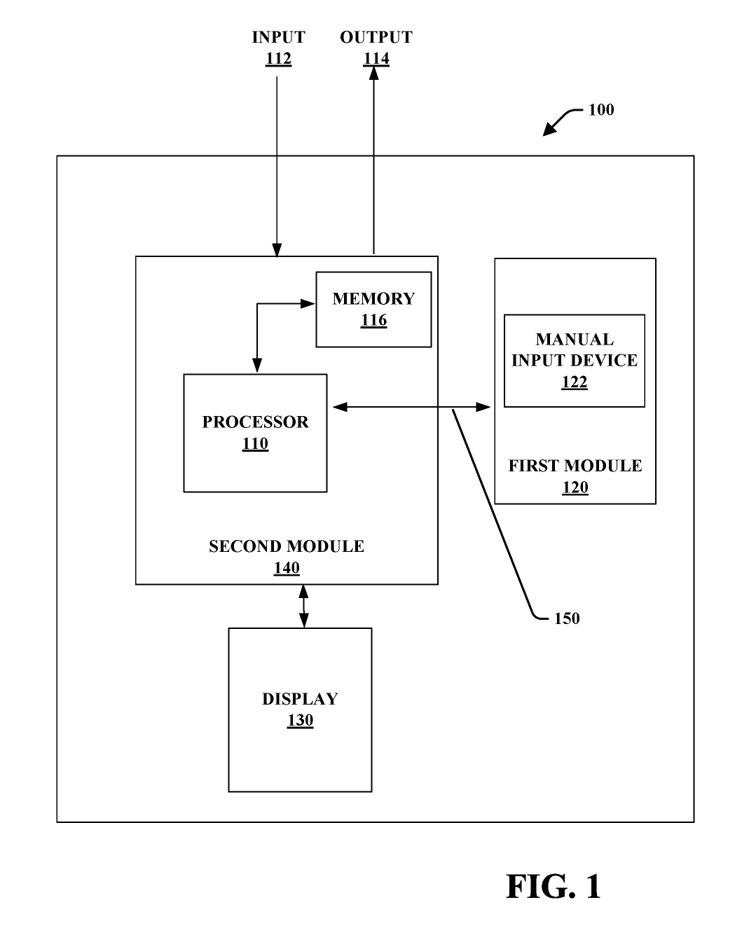

As shown in the electrical block diagram of FIG. 1, brake control unit 100 includes a processor 110 that can receive and send signals 112, 114. The brake control unit 100 may be operatively coupled to a communication bus, such as the high speed controlled area network (HSCAN) bus. For example, the brake control unit 100 can receive and send signals relating to wheel speeds of the towing and/or towed vehicle, vehicle state information from ABS, brake-on-off, etc. The brake control unit 100 can also receive signals from various systems related to the towing vehicle, and can also receive a power signal from a power source, such as a towing vehicle battery.

The brake control unit 100 may include separate modules that may be in communication with one another. In an aspect, the first module 120 and the second module 140 may be located at disparate locations within a towing vehicle (or a towed vehicle). It is noted that the first module 120 and the second module 140 may comprise separate housings or may be comprised within portions of a vehicle.

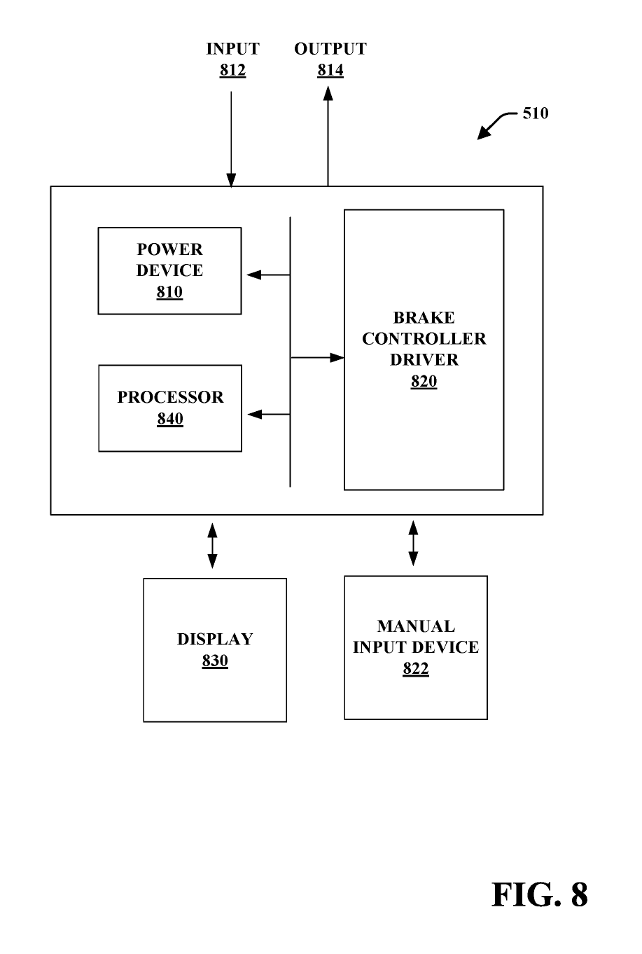

The first module 120 may include manual input devices or interfaces 122 that may be separate from a second module 140. The second module 140 may include the processor 110 or other power and control circuitry (e.g., such as described with reference to FIG. 8 and various other figures). It is further noted that the second module 140 may include a memory 116 that may be configured for storing computer executable components or instructions. Processor 110 may facilitate operation of the computer executable instructions.

Further, the second module 140 (and/or the first module 120) may be in communication with a display 130. It should be understood that any sort of display system can be used including display screens, LEDs, audio devices, projection devices, and the like. Moreover, the display 130 may be either integral with the second module 140 or separate from the second module 140. The brake control unit 100 may drive the display 130 thereof to communicate information such as percentage of brake signal output, gain value settings, and trailer connectivity status. Additionally, the display 130 may include an operator notification system to indicate a connected and disconnected state of the electrical system. In at least one embodiment, the display 130 may be integral with the first module 120. For instance, the manual input device 122 may comprise a touch screen display that may receive input from a user and may function as the display 130.

The brake control unit 100 can be fully integrated with the towing vehicle. This allows the brake control unit 100 to be originally installed equipment in a towing vehicle. In other words, the brake control unit 100 can be a factory-installed option on a towing vehicle. In such circumstances, the first module 120 that includes the manual input devices 122 may be integral to the instrument control panel of the towing vehicle or various other portions of the towing vehicle, such as a steering wheel as described herein. In another aspect, the second module 140 may be located at a remote or disparate location from the first module 120 within the towing vehicle or towed vehicle. Similarly, in one embodiment, the display 130 may be integrated into the instrument panel of the towing vehicle or other portions of the vehicle, such as a steering wheel as described herein. Moreover, the display 130 and manual input devices 122 may comprise single or multiple locations. For example, display 130 may include lights on a steering wheel and a digital display on an instrument panel. Likewise, manual input devices 122 may include interfaces on a display column and interfaces on a steering wheel.

As such, the controls of the brake control unit 100 may operate similarly to the other controls contained in the towing vehicle's instrument panel, steering wheel, or other location. Alternatively, the brake control unit 100 may be an after market device capable of being connected to the towing or towed vehicle allowing the first module 120 be installed separate from the second module 140 within the towing or towed vehicle.

Accordingly, the brake control unit 100 may incorporate a mechanism via software and hardware interface to adjust the various features and functionality of the brake control system. Further, the first module 120 may communicate with the second module 140 via a LIN communication bus, as described in more detail herein. The brake controller unit 100 may communicate and/or control the display 130 or the manual input device 122 of the first module 120. Other inputs may be received at the second module 140 by wireless or wired (e.g., serial, CAN, HSCAN, etc.) communication. Further, as used herein, the term “processor” may include a general-purpose processor, a microcontroller (e.g., an execution unit with memory, etc., integrated within an integrated circuit), a digital signal processor (DSP), a programmable logic device (PLD) or an application specific integrated circuit (ASIC), among other processing devices. The processor may have enough on-board memory to contain the software requirements to communicate with the towing vehicle's communication bus (such as the CAN or a high-speed controlled area network (HSCAN)), or other communication systems (such as a local interconnect network (LIN) and a J1850), in-vehicle diagnostics, and required functionality for interpreting vehicle and driver inputs. It may have the capabilities to provide proper control to the: brakes of the towed vehicle, towing vehicle stop lamps during a manual braking event, towed vehicle stop lamps during a manual braking event, and display information accessible to the operator.

As illustrated by FIG. 1, the processor 110 may be operably coupled to the first module 120 via LIN communication bus 150. The processor 110 may be operable to generate an output signal 114 based on a variety of information received from the towing vehicle (as well as other information from the operator and the towed vehicle). This towing vehicle information can be received through hard-wired inputs from a brake pressure transducer, a brake on-off switch, or an ignition run line. Additional vehicle provided information can be received through the towing vehicle's communication bus. The brake control unit 100 can also send out information on the brake control unit 100 status (e.g., amount of braking induced, type of algorithm selected, gain settings, etc.), status of a trailer, diagnostic information, or the like via the towing vehicle's communication bus as output 140. These messages may be displayed on the display 130.

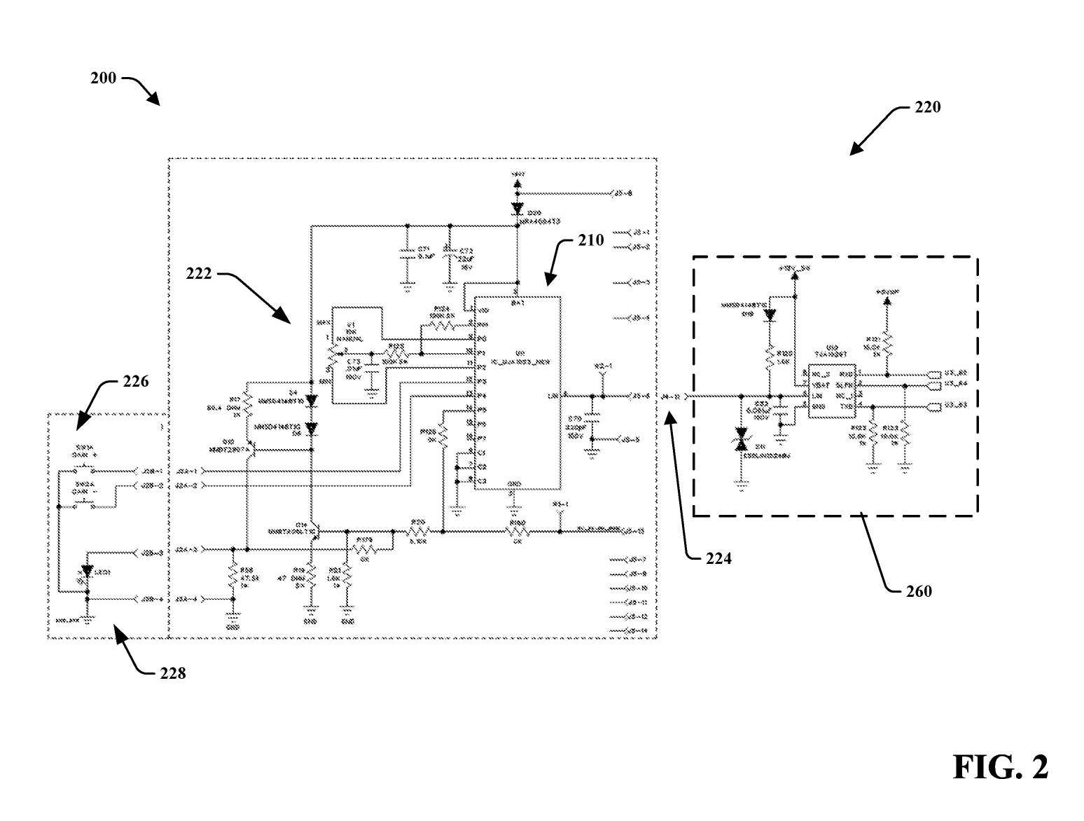

As illustrated by the circuit diagram of FIG. 2, a brake control unit 200, or portion thereof, may include a first module 220 that may control human interfaces and communication with a network (e.g., LIN bus) as described herein. In an aspect, the brake control unit may include a network transceiver 260. It is noted that like named components of brake control unit 200 may comprise similar aspects as those of brake control unit 100. For instance, first module 220 may comprise similar or identical aspects as first module 120.

In an aspect, the network transceiver 260 may receive data from a protocol controller of a network. In at least one embodiment, the first module 220 may primarily include a processor or interface controller 210. The network transceiver 260 may convert the data into a bus signal. In an aspect, the network transceiver 260 may comprise a LIN protocol transceiver. The network transceiver 220 may be in communication with the first module 220 via an electrical connection 224. It is further noted that the interface controller 210 may be controlled by the network transceiver 220 via a master/slave relationship. In some embodiments, the network transceiver 220 may be controlled by the interface controller 210 via the master/slave relationship. Alternatively or additionally, another component may server as a mater/slave.

The interface controller 210 may be coupled to manual input devices, such as a manual slide 222 (which may allow a user to manual apply trailer brakes), gain +/− controllers 226 (which may allow a user to adjust gain settings for a brake control unit), and lighting controls 228 (which may drive an LED or other light). It is noted that the interface controller 210 may control various other or different manual input devices such as trailer backup assist knob, sensitivity controls, trailer brake lighting controls, and the like. It is noted that any type of manual input device may be utilized for any interface, such as a switch, knob, slide, button, lever, toggle, touch sensor, tac-switch, etc.

The interface controller 210 may receive input and/our provide output to the manual interfaces via electrical connections. The interface controller 210 may process input from the manual interfaces and can control the network transceiver 260 to send output via a LIN bus to brake controller circuitry (e.g., a second module), as described herein. In an example, a user may press gain +/− controllers 226 to adjust the gain of a brake controller according to the user's desired settings. The interface controller 210 may receive signals from the gain +/− controllers 226 and may operatively control the network transceiver 260 to transform the signal into an appropriate form for a bus, such as a LIN bus.

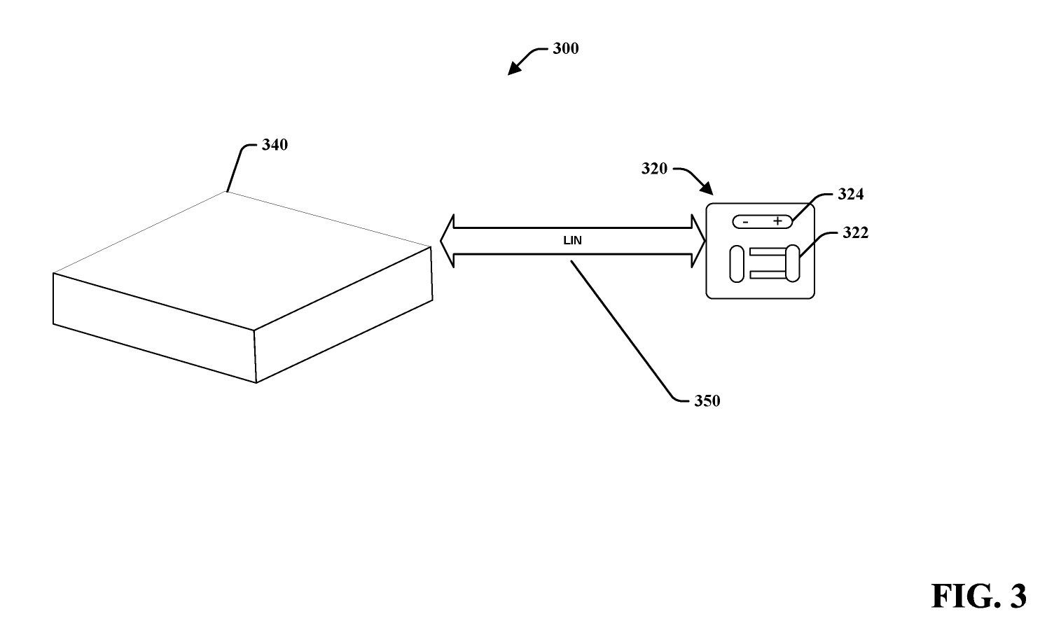

FIG. 3 illustrates an embodiment of a brake controller system wherein a first module 320 is physically separate from a second module 340 but maintains electrical communication via a LIN bus 350. In this embodiment, the first module 320 includes a mechanical sliding module 322 and a plus (+) and minus (−) gain button(s) 324. The sliding module 322 may allow an operator to create a signal related to the position of the slide within the module to manually control trailer brakes. The button(s) 324 may allow the user to increase or decrease the gain settings of the brake controller system 300. The generated signals may be communicated to the second module 340 over the LIN communication bus 350. The first module 320 may be mounted within a convenience position for the operator of the towing vehicle to allow the operator to interact with the first module inputs. In one embodiment, that position may be on a steering wheel of the towing vehicle, as described in more detail herein. The second module 340 may have a slender configuration and may be mounted within the towing vehicle at a remote positon from the first module 320, such as within a control counsel. The second module 340 may receive the input signal from the first module 320 and may process the input to generate a signal to the brakes of the towed vehicle.

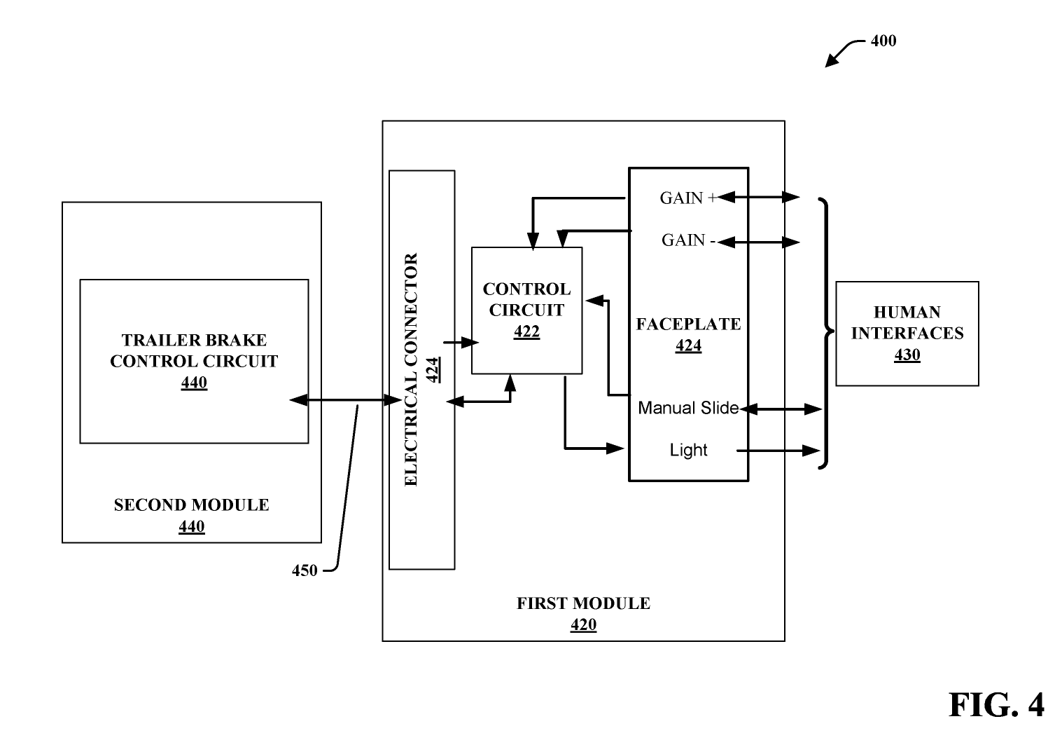

FIG. 4 illustrates a schematic diagram of a brake controller unit 400. It is noted that like named components of brake control unit 400 may comprise similar aspects as those of brake control unit 100, and other disclosed brake control units. In one embodiment, the first module 420 includes a faceplate 424 that may include or be coupled with human interfaces 430. The human interfaces 430 may include inputs such as gain +/− buttons, a manual slider, and an illumination button. These inputs may be in communication with a digital controls circuit 422. The controls circuit 422 may be in communication with an electrical connector 424. The electrical connector 424 may comprise a wired or wireless connector. In at least one embodiment, the electrical connector 424 may comprise a serial port for a LIN bus 450. The second module 440 may include a trailer brake control circuit 440 that may operatively generate control signals to be sent to a trailer. The second module 440 is connected to the electrical connector 424 of the first module 420 with a LIN communication bus 450.

In operation, the embodiments of the instant brake control unit 400 may allow the control human interfaces 430 to be separate from the second module 440 that includes the trailer brake control circuit 440. This allows for flexibility related to installation of trailer brake controller unit 400 and also may reduce the total amount of conductors and size of the wire harness between modules. The LIN communication protocol used between the control module and the power module may allow for transferring and receiving signals between the modules along a single wire.

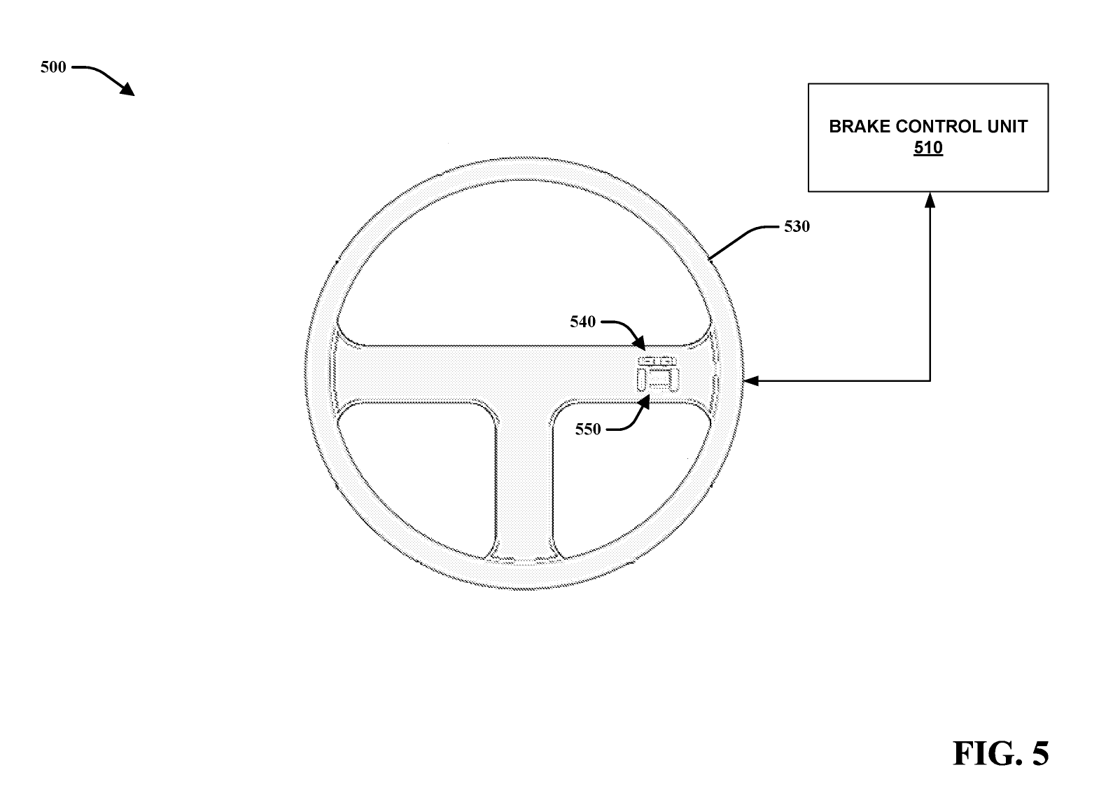

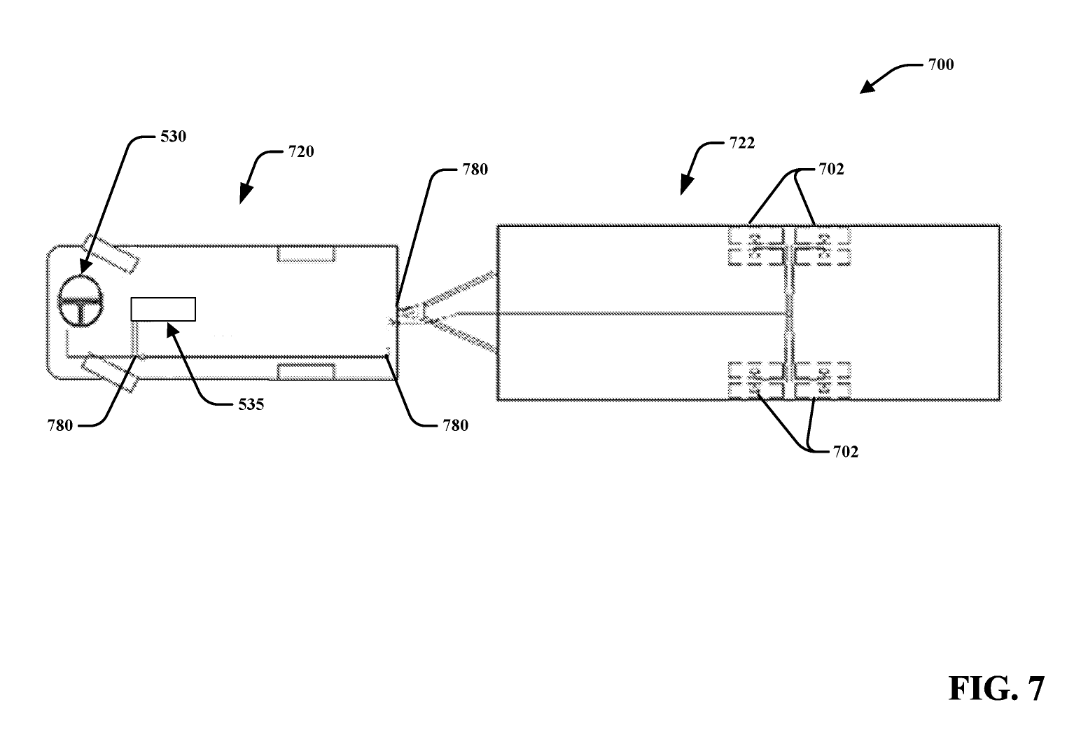

Turning to FIG. 5, there is a system comprising a brake control unit 510 wherein the brake control unit 510, or a portion thereof, is installed on a towing vehicle 720 (as shown in FIG. 7) steering wheel 530. In an aspect, the steering wheel 530 may include manual input devices (e.g., manual input device 120) including a trailer brake gain control 540 (which may comprise a switch, button, toggle, or other interface) and a mechanical sliding module or trailer brake manual override control 550 (which generally includes a sliding manual control but may comprise other interfaces as described herein). The trailer brake gain control 540 and the trailer brake manual override control 550 may be operatively attached to or otherwise included on the steering wheel 530 of the towing vehicle 720 as shown. In such embodiments, trailer brake control circuit (e.g., trailer brake control circuit 440 of FIG. 4) which may include a power module 535 and digital control circuitry (e.g., control circuitry 422 of FIG. 4) may be separated from the trailer brake gain control 540 and the trailer brake manual override control 550, which are positioned on the steering wheel 530. In an aspect, the trailer brake gain control 540 and the trailer brake manual override control 550 may be communicatively coupled to the power module 535 via a vehicle network bus, such as a LIN bus.

Alternatively, the power and control modules may be included in the steering wheel 530. Further still, the trailer brake gain control 540 and the trailer brake manual override control 550 may be integrated directly into the steering wheel 530 or may be positioned on the steering wheel 530 via a fastener (e.g., strap, clip, adhesive, screw, bolt, etc.), such as being attached as an OEM factory component or as an aftermarket component. Moreover, trailer brake gain control 540 and the trailer brake manual override control 550 may be located at different or other locations. For example, the trailer brake gain control 540 may be located on the dashboard 560, while the manual override control 550 may be located on the steering wheel or vice versa. In embodiments, one or more manual input may be disposed on or comprise a shaft or stick. For instance, the brake gain control 540 may be disposed on a shaft similar to a turn light lever/stick.

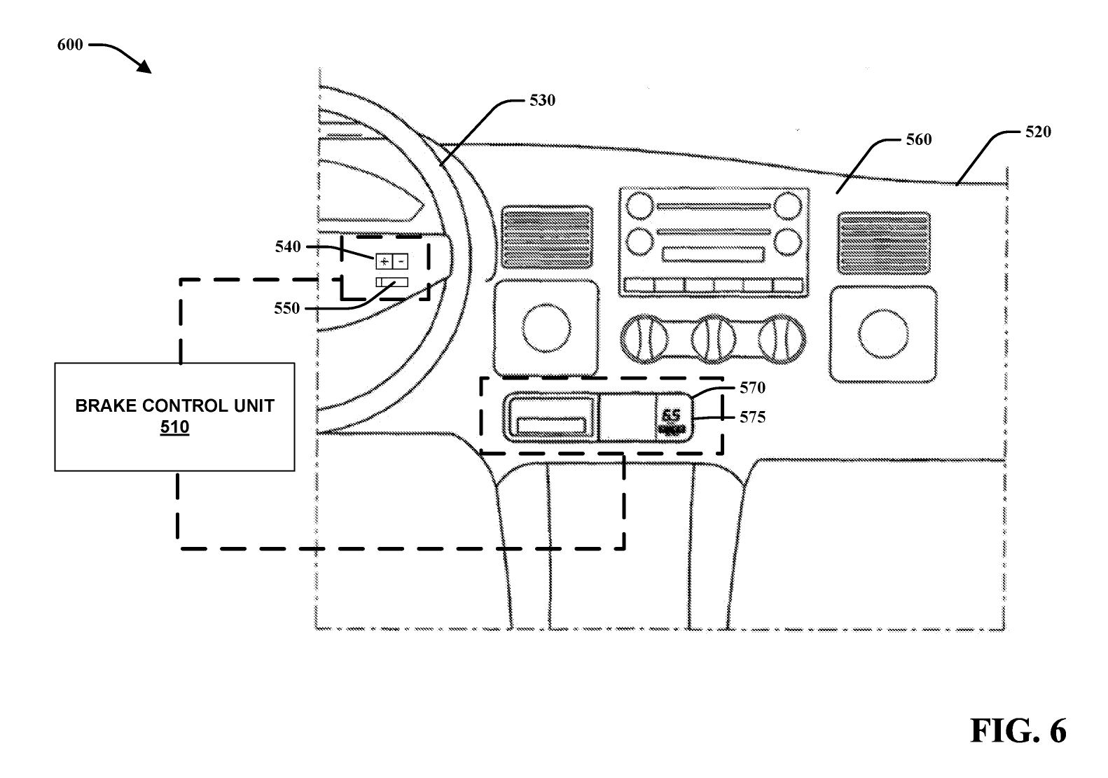

By way of a non-limiting example, as shown in FIG. 6, a portion of the trailer brake control unit 510 may be included in or on a dashboard 560 of the towing vehicle 720. In these embodiments, the control module and/or power module 535 may be integrated into the dashboard 560 of the towing vehicle 720. Further, the trailer brake control unit 510 may include a faceplate display 570 (e.g., faceplate 424) to communicate information such as percentage of brake signal output, gain value settings, and trailer connectivity status. In some embodiments, the brake control unit 510 utilizes a display 575 (e.g., display 130) for displaying the current gain setting, such as two seven segment displays. The brake control unit 510 may use another display or the display 575 to represent the current brake control output level, such as a ten segment bar graph. The display 575 may also include a trailer icon that uses an operator notification system to indicate a connected and disconnected state, e.g., a green state symbolizing the connected state and a red state symbolizing a disconnected state. In an exemplary embodiment, a bi-colored light emitting diode may be used to indicate the towing vehicle connected and disconnected state. In another example a single colored light emitting diode may be utilized where the diode is on when the trailer brakes are connected and off when the trailer brakes are not connected. The display 575, power module 535, control module and other portions of the brake control unit 510, as disclosed herein, may be wirelessly or wiredly coupled with the portion of the brake control unit 510 on the steering wheel 530, e.g., the trailer brake gain control 540 and trailer brake manual override control 550.

Further still, as shown in FIG. 7, the power module 535 may be included in a different area of the towing vehicle 720 as shown. Harness connectors or connectors (or both) 704 may be utilized to operatively attach the power module 535 and control module with the trailer brakes 702 to operatively control the trailer brakes 702. It should be understood, however, that the control and power modules 535 may be located in any part of the towing vehicle 720 or in the towed vehicle 722. Further still, while the trailer brake control unit 510 is shown as including a separate display 575, a display may not be utilized at all or a separate display, such as a smartphone may be utilized.

The brake control unit 510 may be of any appropriate configuration as described with reference to the other figures. By way of a non-limiting example, the brake control unit 510 may generate and apply a particular voltage to the brakes of the towed vehicle to apply a brake load to slow-down or stop the towed vehicle. The voltage applied may be related to the input signals available on and/or from the towing vehicle 720, among other available inputs. These additional input signals may come directly from the operator of the towing vehicle, from the towed vehicle 722, or a combination of any of the three. This may include the operator inputs positioned on the steering wheel 530.

The brake control unit 510 may use a variety of preselected or continuously modified algorithms to generate the appropriate output to the towed vehicle brakes based on the received inputs. A processor on the towing vehicle (although it may be located on the towed vehicle) receives the input signals from the source (such as the ABS system, a speed meter, the ignition, the brake pedal, other processors on the towing vehicle, etc.) and generates the appropriate output signal. It is noted that the brake control unit 510 may comprise algorithms that receive information as input and generate a brake control output as described herein.

The brake output signal controlled by the brake control unit 510 based on information it receives may be represented as a transfer function. It should be understood, however, that the transfer function may include any or all of the input signals listed above in any manner or combination. Additionally, it should be understood that the transfer function is not limited to those input signals listed above.

As shown in the electrical block diagram of FIG. 8, the brake control unit 510 may include a power device 810 (e.g., which may include trailer brake control circuit 440) that can receive and send signals 812, 814 via a communication bus, such as the high speed controlled area network (HSCAN) bus. For example, the brake control unit 510 can receive and send signals 812/814 relating to wheel speeds of the towing and/or towed vehicle, vehicle state information from ABS, brake-on-off, etc. The brake control unit 510 can also receive signals from various systems related to the towing vehicle, and can receive a power signal from a power source, such as a towing vehicle battery. It is noted that the brake control unit 510 may include similar aspects as brake control unit 100, as described herein.

The brake control unit 510 may include a display 830 as is described above. It should be understood that any sort of display system can be used. The brake control unit 510 may drive the display 830 thereof to communicate information. The brake control unit 510 may be controlled by the display 830 through a LIN bus or other vehicle network, such as by serial communication. Further, to operate the components above, the brake control unit 510 may include a processor 840, which may include similar aspects as described with reference to processor 110 of FIG. 1.

As illustrated by FIG. 8, the processor 840 may be operably coupled to the power device 810 and the brake control unit driver 820, which may be connected via a LIN bus as described herein. The brake control unit driver 820 may be operable to generate an output signal 814 based on a variety of information received from the towing vehicle 720 (as well as other information from the operator and the towed vehicle). This towing vehicle information can be received through hard-wired inputs from a brake pressure transducer, a brake on-off switch, and an ignition run line. Additional vehicle provided information can be received through the towing vehicle's communication bus. The brake control unit 510 also sends out information on the brake control unit 510 status via the towing vehicle's communication bus. These messages may be displayed on the display 830.

Additionally, the brake control unit 510 (as wells as other brake control units described herein) may receive an input signal from the brake pressure transducer (BPT). The BPT input signal can be received via the towing vehicle's communication bus or through hard-wired inputs. This input signal represents the braking effort by the operator. The brake control unit can also receive an input signal from the towing vehicle's anti-lock braking system (ABS) to adjust the application of the towed vehicle's brakes. In particular, the algorithm applies the ABS signal of the towing vehicle and responds to that signal by altering the brakes of the towed vehicle based on the ABS event. For example, the algorithm can cause the towed vehicle to continue to fully brake if the ABS is triggered due to wheel slip on a high μ surface, or can be used to reduce the braking to the towed vehicle if the ABS condition results from braking on a low or split μ surface.

In addition to automatic inputs, the brake control unit 510 can use inputs manually entered from an operator to control the output of the towing vehicle brakes by using predetermined algorithms, modifiable algorithms, or both. In particular, an operator can manually enter an input and the brake control unit can output a brake output signal that can apply the brakes of the towed vehicle in a predetermined manner based on such input.

One operator input available is the gain control 540, which may be present on the steering wheel 530 of the brake control unit 510. The gain control 540 can provide several different inputs to the brake control unit 510. For example, holding the gain control 540 simultaneously with the brake-on-off active input may allow the brake control unit 510 to change its configuration to allow the algorithm to convert from electric brake curves to electric over hydraulic algorithms (or brake curves). Other operator interface controls of the brake control unit 510 can be used in combination to achieve other means to alter configurations of the brake control unit 510 and may be positioned on the steering wheel 530. Since the load sensing and performance curves are significantly different for the two types of braking systems, this allows for adapting the brake control unit 510 via the operator input to a unique algorithm(s) for electric over hydraulic brakes. Also, the display 575 can show the use of the alternate configurations to notify the operator of the configuration currently set. For example, a flashing digital character representation may show that the brake control unit is interfacing to an electric over hydraulic braking system.

Another input the gain buttons 40 can provide is to adjust the maximum duty cycle available. More specifically, if manual activation occurs during a normal or ABS braking event the greater of the two duty cycles, i.e., a normal ABS event or a limited operating strategy (LOS) deceleration braking event, is used. The determined duty cycle is then adjusted according to the current gain setting. The gain setting is used as a multiplier to the duty cycle. Therefore, it will produce an output that is scaled to a certain percentage of the current braking level the operator is requesting. For example, if the operator is requesting 75% desired braking capacity at a gain setting of 6.0, the brake control unit will provide 45% of the maximum duty cycle available (60% times 75%).

Additionally, along with the gain setting the reference speed is inputted into a transfer function. This scales the gain adjusted duty cycle output according to the towing vehicle speed. At low speeds, a scaled percentage of the brake output signal is computed based on the curve that is present in a lookup table present in the processor. This thereby causes reduced braking strength at lower speeds to prevent the brakes of the towed vehicle from jerking. At higher speeds, the brake output signal is set to 100% of calculated duty cycle. This duty cycle value is stored to be used for the output display on the brake control unit console. The unadjusted value of this signal is used to drive the bar graph display, thereby, communicating to the operator the total level of braking requested at a specific gain setting.

As showing in FIG. 5, the present embodiment of the brake control unit 510 can use two buttons for gain control 540, one to increase and one to decrease the gain setting. Pressing each button activates its own momentary push switch. It should be understood, however, that any number of buttons can be used herewith. Additionally, any sort of device can be used, not just the buttons shown. For example, one could use a slide, knob, touch-screen, etc.

Another operator input that can be disposed on the steering wheel 530 is a manual override control 550. The manual override control 550 can be, e.g., a manual slide having a linear travel potentiometer, controlled by the towing vehicle operator. In this embodiment, the manual slide can be integrated into or otherwise attached to the steering wheel 530 and may be spring-loaded to an at rest (inactive) position. This input to the brake control unit 510 allows the operator to manually apply towed vehicle brakes without having to depress the brake pedal. The manual override control 550 is mainly used in conjunction with the gain adjustment buttons 40 described above to calibrate maximum towed vehicle braking available based on specific towed vehicle loading, towed vehicle tire and brake conditions, and road conditions. Normal maximum is that braking force that is just short of causing the wheels of the towed vehicle to skid. When the operator activates the manual override control 550 the brake control unit 510 sends a signal over the communication bus to the towing vehicle 720. Additionally, whenever there is a normal braking event, e.g., the operator depressing the brake pedal of the towing vehicle, a signal is also sent to the towing vehicle from the brake control unit 510 via the communication bus.

In order to communicate between the towing vehicle 720, the towed vehicle 722, and the brake control unit 510, the brake control unit 510 may utilize communication bus methods. The brake control unit 510 extracts data from the towing vehicle's bus as well as transmits information to the towing vehicle's bus to interface with other subsystems in the towing vehicle, e.g., cluster, ABS, vehicle stability systems, transmissions, dimming features, etc. The brake control unit 510 is in constant communication with the towing vehicle's communication systems

The brake control unit 510 collects and stores information in memory, for example in electrically erasable programmable read-only memory (EEPROM) or Flash memory, to allow for diagnostics, life cycle management, etc. of the brake control unit 510, the towing vehicle 720, and/or the towed vehicle 722. More specifically, the brake control unit 510 can read and store the number of ignition cycles, the gain adjustments, number of manual activations, the VIN of the towing vehicle, calibration data, other defect codes during the life of the brake control unit, serial number of the brake control unit, date of manufacture of the brake control unit, and other configuration management data of the brake control unit. This information is useful in understanding the life of the brake control unit 510 as well as representing the conditions the brake control unit has been subjected to throughout its life. For example, storing the serial number of the brake control unit 510 helps traceability of the unit itself as well as the components that make up the unit. This helps with the serviceability of the unit and its components. Additionally, the diagnostic section determines if a valid fault exists. If it does, it is stored in memory. Again, this assists a technician with maintenance of the brake control unit 510. Finally, depending on the severity of the fault the towing vehicle 720 may be notified that a serious fault exists that could hinder the normal operation of the brake control unit 510. The towing vehicle 720 will notify the operator of such fault occurring, for example, through the cluster message center. If the fault is not severe, it is merely stored in memory to be accessed by a technician at a later time.

It should be understood that the foregoing description is a description of an exemplary brake control unit. The present teachings are not limited to the embodiment disclosed above. Any configuration of brake control unit may be utilized without departing from the present teachings. Moreover, while the description describes the brake control unit being integrated with the steering wheel, it may also be attached to the steering wheel as an aftermarket component. It may be attached in any manner, such as being directly attached into the steering wheel or attached on the steering wheel.

Modification of the invention will occur to those skilled in the art and to those who make or use the invention, including, without limitation, the values provided for the various elements disclosed above. It should be understood that such values are exemplary values and the present invention is not limited to those values. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

1. A brake control unit comprising:
a trailer brake control circuit comprising:
a processor that operatively generates an output signal to control brakes of a towed vehicle; and
an electrical connection coupled to the processor; and
a user interface operatively generating an input signal to be sent to the trailer brake control circuit in response to actuation of the user interface,
wherein the user interface is coupled to the electrical connection via a local interconnect network bus.

2. The brake control unit of claim 1, wherein the user interface comprises a manual brake control mounted in a steering wheel.

3. The brake control unit of claim 2, wherein in the manual brake control comprises a slide control.

4. The brake control unit of claim 1, wherein the user interface comprises a gain control in a steering wheel.

5. The brake control unit of claim 4, wherein the gain control comprises a first control for increasing a gain setting and a second control for decreasing a gain setting.

6. The brake control unit of claim 1, wherein the user interfaces comprises an original equipment manufactured device.

7. The brake control unit of claim 1, wherein at least part of the user interface is disposed in a control column of a vehicle.

8. The brake control unit of claim 1, wherein at least part of the user interface is disposed in a steering wheel of a vehicle.

9. The brake control unit of claim 1, wherein the electrical connection comprises a serial port.

10. A brake control unit comprising:
a first module comprising:
a controller coupled to at least one manual input device; and
a network transceiver coupled to the controller; and
a second module comprising a brake control circuit that generates an output signal to control brakes of a towed vehicle,
wherein the network transceiver operatively converts a signal between the first module and the second module.

11. The brake control unit of claim 10, wherein the network transceiver comprises a local interconnect network transceiver.

12. The brake control unit of claim 10, wherein the first module is physically separate from the second module.

13. The brake control unit of claim 10, wherein the first module further comprises a manual input device coupled to the controller.

14. The brake control unit of claim 10, further comprising a local interconnect network bus coupling the network transceiver to the second module.

15. A brake control unit comprising:
a trailer brake control circuit that operatively generates an output signal to control brakes of a towed vehicle; and
a user interface coupled to the trailer brake control circuit and integrated with a steering wheel of a vehicle.

16. The brake control unit of claim 15, wherein the user interface includes at least one of a gain control, a light, or a manual brake control.

17. The brake control unit of claim 15, further comprising a display coupled to the trailer brake control circuit and mounted in a different location than the user interface.

18. The brake control unit of claim 15, wherein the user interface device is coupled to the trailer brake control circuit through a network of the vehicle.

19. The brake control unit of claim 15, wherein the brake control circuit is disposed within a housing.

20. The brake control unit of claim 15, wherein the housing is removably disposed in a towing vehicle.
